(19) United States
(12) Patent Application Publication
(10) Pub. No.: US 2026/0017972 A1
(43) Pub. Date: Jan. 15, 2026

(54) EXTRACTING IMAGES AND DETERMINING THEIR MEANING FOR SEMANTIC IMAGE RETRIEVAL AND TRAINING A TRANSFORMER-BASED MULTI-MODAL LARGE LANGUAGE MODEL TO GENERATE DOMAIN-AWARE IMAGES BASED ON IMAGE MEANINGS

(71) Applicant: ROHIRRIM, INC., St Paul, MN (US)

(72) Inventor: Steven Thomas ABERLE, St Paul, MN (US)

(73) Assignee: ROHIRRIM, INC., St Paul, MN (US)

(21) Appl. No.: 19/266,519

(22) Filed: Jul. 11, 2025

Related U.S. Application Data
(60) Provisional application No. 63/670,320, filed on Jul. 12, 2024.

(51) Int. Cl. G06V 30/413; G06F 16/56; G06F 40/40; G06V 10/44; G06V 10/764; G06V 30/18; G06V 30/19; G06V 30/414

(52) U.S. Cl. CPC G06V 30/413; G06F 16/56; G06F 40/40; G06V 10/44; G06V 10/764; G06V 30/1801; G06V 30/19173; G06V 30/414

(57) ABSTRACT

The disclosure relates to systems and methods automatically extracting an image and related image components, computationally determining an understanding of the image, and generating mathematical vector embeddings via sentence encoders based on the computationally determined understanding. The mathematical vector embeddings may be used for semantic image retrieval that enables image searching based on a semantic understanding of input images and/or input text. The mathematical vector embeddings may be used for training and executing generative Artificial Intelligence (AI) models to create new content that includes retrieved images and/or generate new images.

### CROSS REFERENCE TO RELATED APPLICATIONS

This application claims priority to U.S. Provisional Patent Application No. 63/670,320, filed on Jul. 12, 2024, of which is incorporated by reference in its entirety herein for all purposes.

### BACKGROUND

Transformer-based Large Language Models (“LLMs”) may be pretrained to generate text. Image-based generative models purport to generate images. However, training these image-based generative models may require a large set of images and an understanding of what these images convey. While transformer-based LLMs may be trained to understand natural language text, they may not understand the meaning or intent of images. This is in part because an image may include text encoded in a way that the LLMs cannot read, or text and the relationship between text and image objects are not encoded during the training process. Text within images and their primary, secondary, tertiary and distance relationships to image objects, which can be potentially important data for understanding the meaning of the image, may not be useful and are not considered as training objects for LLMs. Furthermore, contextual information that may describe the image can be difficult to identify and extract when images are embedded within an electronic document.

### SUMMARY

Various systems and methods may address the foregoing and other problems by automatically extracting an image and related image components, computationally determining an understanding of the image, and generating mathematical vector embeddings via sentence encoders based on the computationally determined understanding. The mathematical vector embeddings may be used for semantic image retrieval that enables image searching based on a semantic understanding of input images and/or input text. The mathematical vector embeddings may be used for training and executing generative Artificial Intelligence (AI) models to create new content that includes retrieved images and/or generate new images.

For example, a system may identify images in electronic documents using computer vision models that perform edge detection and/or other image detection techniques. The location of an identified image in the electronic document, such as x and y coordinates of the image, may be stored for later analysis. The system may recognize or otherwise obtain machine text for each image or image component, and determine and store the location of each image or image component.

In some instances, a given image will include multiple image objects. Each object is a part of the image distinct from other objects. Each object may separately convey meaning within the image. The system may recognize each object and determine relationships between the object and other objects. For example, the system may generate a hierarchical relationship of objects within an image to gain deeper insights into the information the objects and therefore image conveys and how the image conveys the information.

To further understand the meaning of an image, the system may identify various image components such as text that may describe the image. For example, the system may train and execute layout models that are trained to identify image headers, image figure descriptions, text in an electronic document that may be relevant to the image, and/or other text associated with the image. In some examples, the system may recognize the text within the image via OCR. In this way, the system may recognize and later analyze text that is both machine readable text and text that has been recognized through OCR.

Once the text, relationships, image, and objects have been identified, the system may execute multi-modal transformer-based LLM to determine an understanding of the image. For example, the system may execute the multi-modal transformer-based LLM to generate a first image description of the image based on the recognized text and a second description of the image based on the image itself. The system may then execute the multi-modal transformer-based LLM to compare the first image description and the second image description and then generate an image description based on the comparison. The system may vectorize the image description to generate mathematical vector embeddings (also referred to as “vector” for simplicity) based on the image description.

Using the vector, the system is able to semantically search the image based on semantic similarity to an input. Semantic similarity is a measure of similarity based on semantic content (meaning, context, or structure of words) rather than keyword matching. For example, “transportation” may be semantically similar to “automobile.” In this context, semantic similarity may refer to the similarity in meaning of words, context or structure of descriptions that describe an image.

The input may include text that describes an image. For example, a user may provide text as an input (such as the query input: “find an image relating to a response to a specific requirement”). The system may generate a vector based on the text input, and execute a semantic search based on the vector. Alternatively, or additionally, the input may include an image input. In this example, the user may provide an input “find me images similar to this image” and then provide an input image. The system may generate a description of the input image, vectorize the description, and execute a semantic search based on the vector.

In some examples, the system may determine an understanding of images (including relationships of objects) in a training dataset, generate vectors based on the analyzed images, and train a generative AI image model that generates new content or images.

### BRIEF DESCRIPTION OF THE DRAWINGS

Features of the present disclosure may be illustrated by way of example and not limited in the following figure(s), in which like numerals indicate like elements, in which:

FIG. 1 shows an illustrative system for determining an understanding of images, a smart retrieval platform for searching images based on the understanding, and generative content creation based on the understanding, according to an implementation.

FIG. 2 illustrates an example of an electronic document and examples of content the computer system recognizes from the document, according to an implementation.

FIG. 3 illustrates an example of primary objects recognized from an image, according to an implementation.

FIG. 4 illustrates an example of secondary objects recognized from primary object illustrated in FIG. 3, according to an implementation.

FIG. 5 illustrates an example of tertiary objects to N objects recognized in the image, according to an implementation.

FIG. 6 illustrates an example of an architecture and data flow of the generative AI-based image understanding subsystem, according to an implementation.

FIG. 7A illustrates an example of objects recognized in an electronic document and determining their relationships with respect to one another, according to an implementation.

FIG. 7B illustrates an example of determining distance and other relationships between objects recognized in an electronic document, according to an implementation.

FIG. 8 shows an illustrative method for computationally determining an understanding of an image, according to an implementation.

FIG. 9 shows another illustrative method for computationally determining an understanding of an image, according to an implementation.

FIG. 10 shows an illustrative method for semantically searching images based on computationally determined understanding of images, according to an implementation.

### DETAILED DESCRIPTION

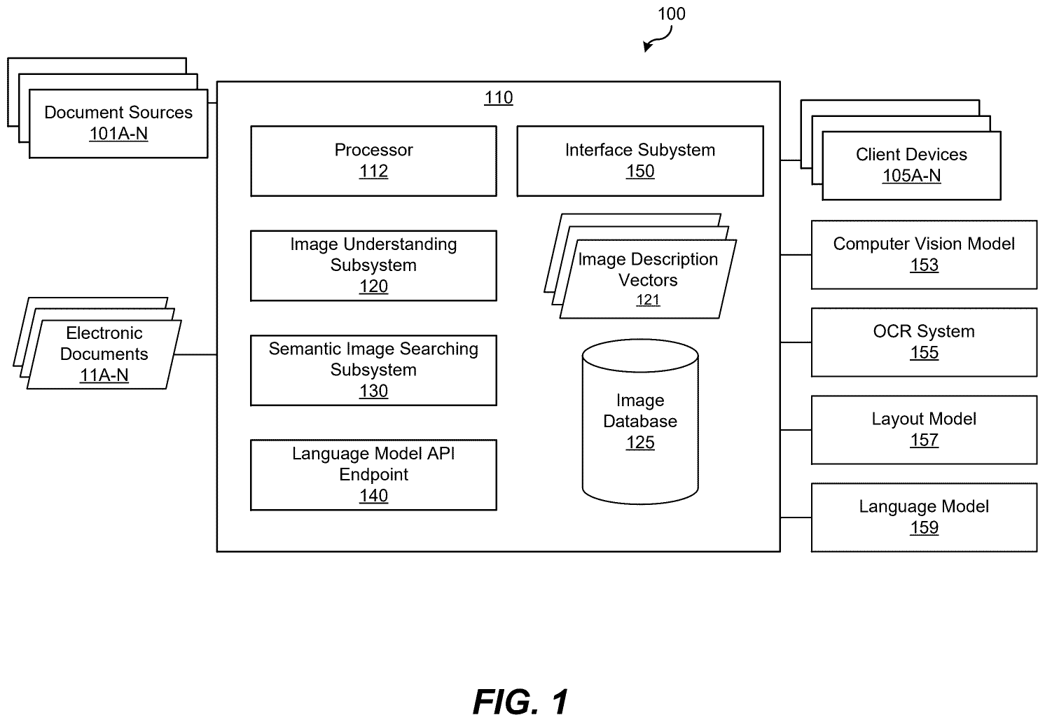

FIG. 1 shows an illustrative system 100 for determining an understanding of images, a smart retrieval platform for searching images based on the understanding, and generative content creation based on the understanding, according to an implementation. The system 100 may include one or more document sources 101 (illustrated as document sources 101A-N), one or more client devices 105, a computer system 110, and/or other components. A document source 101 may store a plurality of electronic documents 11 (illustrated in FIG. 1 as electronic documents 11A-N).

An image is a visual or graphical element. An image can include characters that are embedded as fonts, metadata and/or characters that are graphically represented such as through the arrangement of pixels to form characters. An image can be electronically stored and represented as a binary image object, or simply “binary object.” Determining an understanding of an image is a computational process of identifying information the image is intended to convey based on computer analysis of the image. For example, the understanding can be a computationally determined description: “this image is a bar graph that conveys sales over time.” Based on the computationally determined understanding of the image, the computer system 110 may perform enhanced image search and retrieval and/or train generative AI models to create computer-generated content. Computer generated content is unique content generated by a computer based on previously generated content or images. For example, a generative AI model may retrieve relevant images from a repository of images based on the understanding and incorporate those images into computer generated content. Alternatively or additionally, a generative AI model may generate new images based on the retrieved images.

An electronic document 11 is content that can be written, read, modified, or otherwise accessed by a computer. An electronic document 11 may include documents that have been generated by a computer program and/or hand-written/drawn and later copied, such as being scanned or photographed, for storage on a computer. Examples of an electronic document 11 may include a word processing document, a spreadsheet, a portable document format (“PDF”) file, a webpage such as a HyperText Markup Language (“HTML”) document, an image file (including still images such as photos or motion images such as videos), and/or other types of documents that can be accessed by a computer. The electronic document may include content such as one or more images, natural language text, and/or other content. The content may be structured or unstructured in that the content includes sections or portions of content that are not explicitly labeled or ordered.

An electronic document 11 may include text, images, and/or other content. In some instances, an electronic document 11 may include content that is not displayed, such as metadata that describes content or other aspect of the electronic document 11.

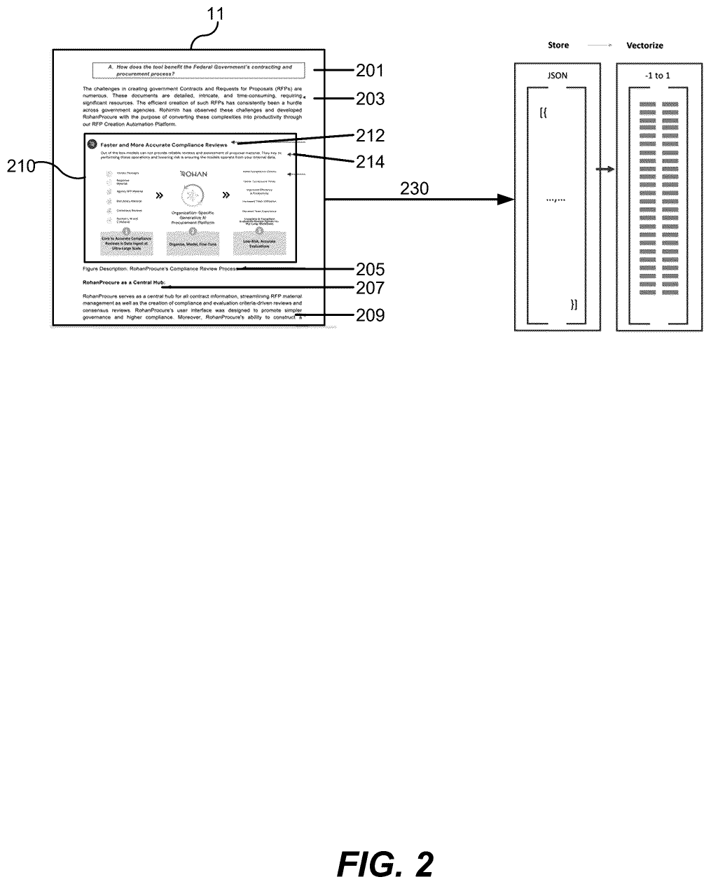

The computer system 110 may identify, and in some instances extract, various content from the electronic document 11 for analyzing images contained therein. An example of different types of content that are identified, and in some instances extracted from the electronic document 11, will be described with reference to FIGS. 2-5.

FIG. 2 illustrates an example of an electronic document 11 and examples of content (201, 203, 205, 207, 209, 210, 212, 214) the computer system 110 recognizes from the document, according to an implementation. Only one page or portion of the electronic document 11 is shown for illustration. The electronic document 11 may include various document portions, such as a section header 201, text above image 203, an image 210, an image header 212, an image text 214, an image figure description 205, an image sub-header 207, and text below image 209. The position (such as x, y positions in the image) of each object and their relationships (“Image x, y position and relationships 230”) may be determined and stored for later processing.

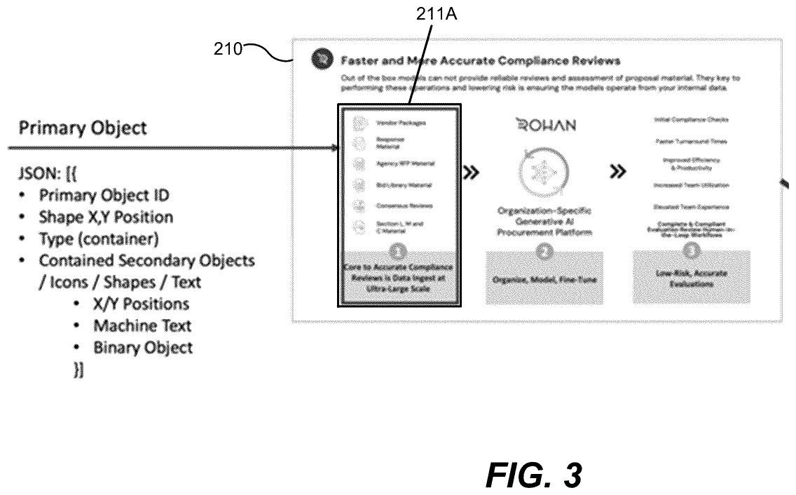

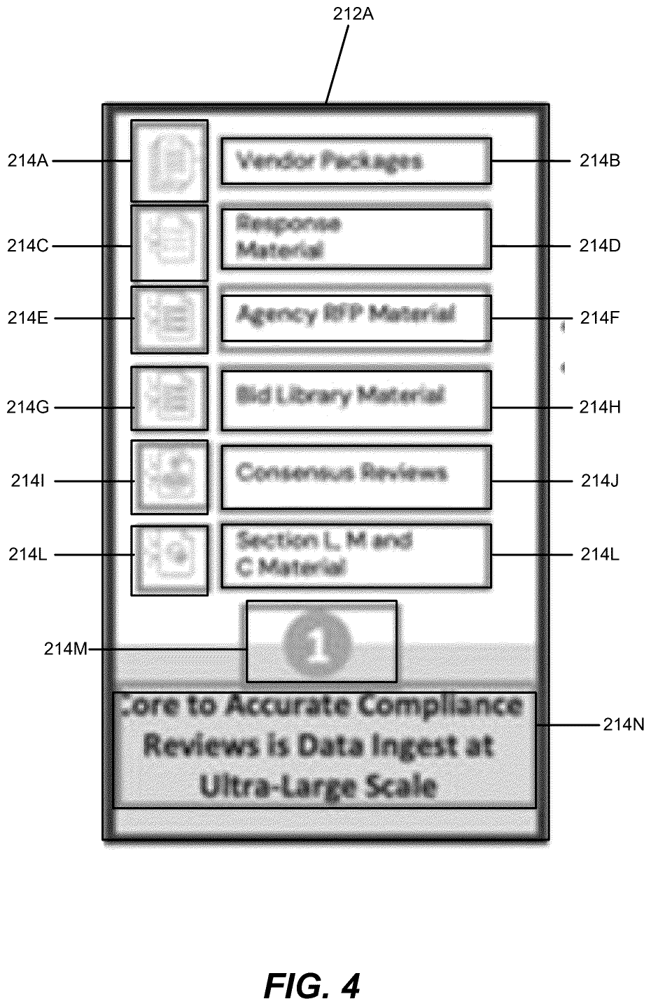

FIG. 3 illustrates an example of primary objects 212A-N recognized from an image 210, according to an implementation. For each primary object 211, the computer system 110 may assign a primary object identifier (ID), determine and store position information (such as x, y position data indicating the location and in some cases shape of the primary object in the image 210, a type of object (such as being an image container object), and each of one or more secondary objects that is contained in the primary object 211 and its corresponding data (such as position information for each secondary object, machine text, and the binary object), as shown in FIG. 4.

FIG. 4 illustrates an example of secondary objects 214A-N recognized from primary object 211A illustrated in FIG. 3, according to an implementation. For each secondary object 215, the computer system may assign a primary object relationship ID that links the secondary object to its primary object (in this case primary object 211A), position information (such as x, y position data indicating the location and in some cases shape of the secondary object), type of object, machine text determined from the secondary object, the binary image, a distance from the primary object (such as x, y distance of an edge of the secondary object from an edge of the primary object to understand the spatial relationship between the primary object 211 and the secondary object 215), and any of its contained objects (because, similar to primary objects, secondary objects can contain image, text, or other objects such as tertiary objects, which are 3^{rd}-order related or further nested objects that have shown precedence or effect from primary or secondary objects) and corresponding data of the contained objects.

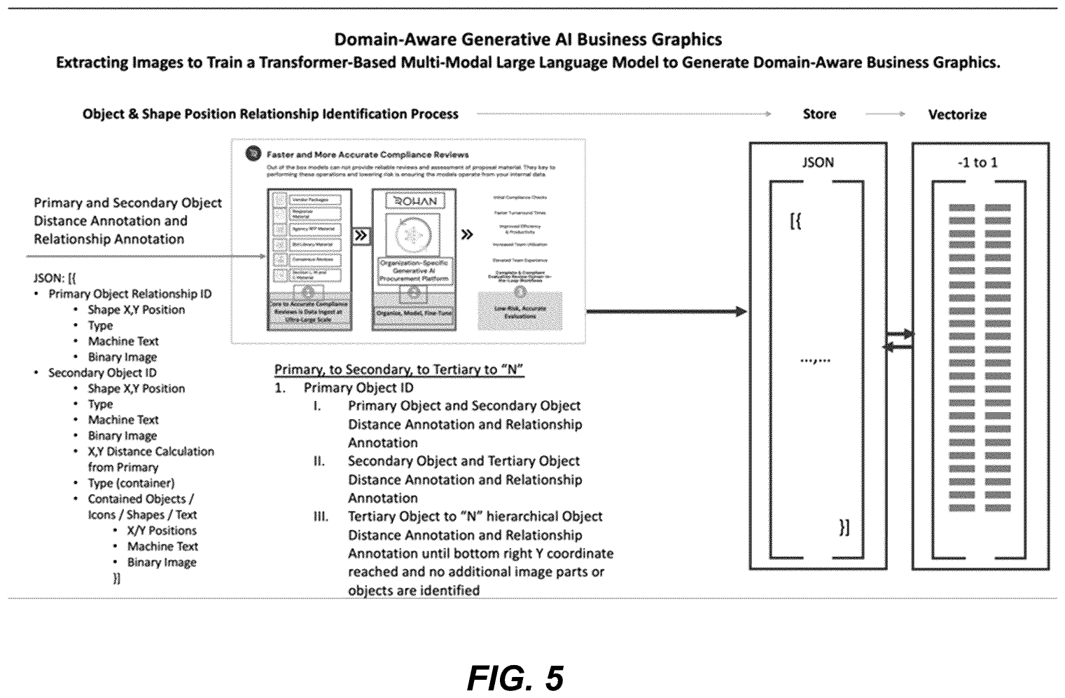

FIG. 5 illustrates an example of tertiary objects 216 to N objects recognized in the image 210, according to an implementation. For each tertiary object 216, the computer system may store a linkage between the tertiary object 216 and a primary object 211, primary object and secondary object distance annotation indicating distance between the primary and secondary objects, primary object and secondary object relationship annotation indicating a relationship (such as “is to the left of” between the primary and secondary objects, secondary object and tertiary object distance and relationship annotations, tertiary objects N other hierarchical object distance and annotation relationships. For example, the computer system 110 may analyze the image 210 (such as from top left to bottom right) and recognize N objects until the entire image 210 is processed. Other types of image recognition in which the entire image 210 is analyzed may be performed as well, so long as all objects in the image 210 can be recognized.

Returning to FIG. 1, the computer system 110 may include one or more subsystems that train and/or execute one or more computer models or systems to analyze electronic documents 11, identify and extract content such as images, determine an understanding of the images, and based on the understanding: (1) generate a semantically searchable image database and/or (2) train and execute generative models to create new images. For example, the computer system 110 may include a processor 112 that is programmed to execute one or more computer program components. The processor 112 may include one or more of a digital processor, an analog processor, a digital circuit designed to process information, an analog circuit designed to process information, a state machine, and/or other mechanisms for electronically processing information. Although processor 112 is shown in FIG. 1 as a single entity, this is for illustrative purposes only. In some implementations, processor 112 may comprise a plurality of processing units. These processing units may be physically located within the same device, or processor 112 may represent processing functionality of a plurality of devices operating in coordination.

The computer program components may include software programs and/or algorithms coded and/or otherwise embedded in processor 112, for example. The one or more computer program components or features may include various subsystems such as a image understanding subsystem 120, a semantic image searching subsystem 130, a language model Application Programming Interface (API) endpoint 140, an interface subsystem 150, and/or other components. These subsystems may train and/or execute computer models, such as a computer vision model 153, an Optical Character Recognition (OCR) system 155, a layout model 157, a language model 159, and/or other models or systems.

The computer vision model 153 is a computer model that is trained to process, understand, and identify objects in electronic visual data such as images. Examples of computer vision models include GPT-4V, LaVA (Large Language and Vision Assistant), and BakLLaVA. These or other computer vision models 153 may integrate image identification and language understanding that provides an ability to analyze visuals and ask questions of the images. In computer vision, edge detection may be used to identify the boundaries between objects in an image. A boundary is a location in which a change is detected in an image. Boundaries may be used to recognize an individual object from other objects, separate an object from the background (segmentation), and extract important features. Edges are often characterized by changes in brightness or color intensity. The computer vision model 153 achieves this by calculating the “gradient” of the image. A gradient includes a direction and magnitude of intensity change at each pixel. Areas with high gradients are likely edges. Edge detection can include Canny Edge Detection in which gradients are combined with non-maximum suppression (thinning edges) and hysteresis thresholding (keeping only strong edges). Convolutional Neural Networks (CNNs) may also or instead be used for edge detection. CNNs are trained on large datasets of images with labeled edges, allowing them to learn complex patterns and improve accuracy for detecting edges. The computer vision model 153 may use edge detection to identify the boundaries of individual objects in an image 210.

The OCR system 155 performs OCR to recognize text from images. OCR is executed against the stored image in its transformed file type (JPEF, PNG, TIFF, etc) to identify textual components, whether computer generated fonts or handwritten text.

The layout model 157 may determine a structure of a document such as an unstructured or structured document. In some instances, the layout model 157 may be trained learn to identify structure in unstructured documents. The layout model 157 may transform unstructured content into structured content by identifying each type of content in the unstructured content and assigning a label for each type. For example, the layout model 157 may use a machine-learning model that uses deep learning and natural language understanding (NLU) to identify sections of unstructured content and classify (assign a label to) each of the identified sections. The machine-learning model may use text classification techniques using annotated content sections of a subset of the unstructured content for deep learning. The annotated content sections are associated with labels assigned by human annotators. Once the machine-learning model is trained on the subset, the layout model 157 may apply the machine-learning model to structure and label sections in other electronic documents 11. The layout model 157 may generate a data structure that structures the identified and labeled sections into structured content. It should be noted that different machine-learning models may be trained to recognize different types of content in an electronic document 11. For example, the layout model 157 may use a first machine-learning model to recognize text above image 203 and a second machine-learning model to recognize an image header 212.

An example of labeling systems that can be used is described in U.S. Pat. No. 11,748,577, issued Sep. 5, 2023, which is incorporated by reference in its entirety for all purposes, may be used. In this example, the layout model 157 may be trained to identify sections or parts of the document to identify each type of content (including text sections and images) in an electronic document 11, as well as sections and text that may be relevant to or otherwise describe images in the document.

The language model 159 is a model trained to understand language, such as words or phrases in natural language text. For example, the language model 159 may be a pretrained deep-learning Large Language Models (“LLM”) trained on large language datasets. In particular, the language model 159 may be a multi-modal transformer-based LLM that is trained using text and images so that the inputs to the model can include text and/or images. The language model 159 may be trained to semantically understand natural language and automatically generate new text based on this understanding. Examples of the language model 159 may include, without limitation, one or more variants of: OpenAI GPT, LLaMA from META, Google LaMBDA, BERT from GOOGLE, BigScience BLOOM, Multitask Unified Model (MUM), or other language models. A language model 159 may be activated with one or more input prompts and one or more model parameter values. That is, the language model 159 may be executed by providing it with an input prompt, a model parameter value, and/or other input. A model parameter value is an input that specifies behavior—and therefore output—of the language model 159. For example, a model parameter value may include a temperature parameter that adjusts the level of randomness for automatically generated text. Different temperature parameter values will result in different levels of randomness in the generated text. Thus, the temperature parameter value may be used to control the output of the language model 159.

Transformer-based LLMs may be trained to understand natural language text, but understanding images in documents remains difficult. This is in part because an image may include text encoded in a way that the LLMs cannot read rather than a text encoding. Thus, text in images, which can be potentially important data for understanding the meaning of the image, may not be useful for LLMs. Furthermore, contextual information that may describe the image can be difficult to identify and extract when images are embedded within an electronic document 11.

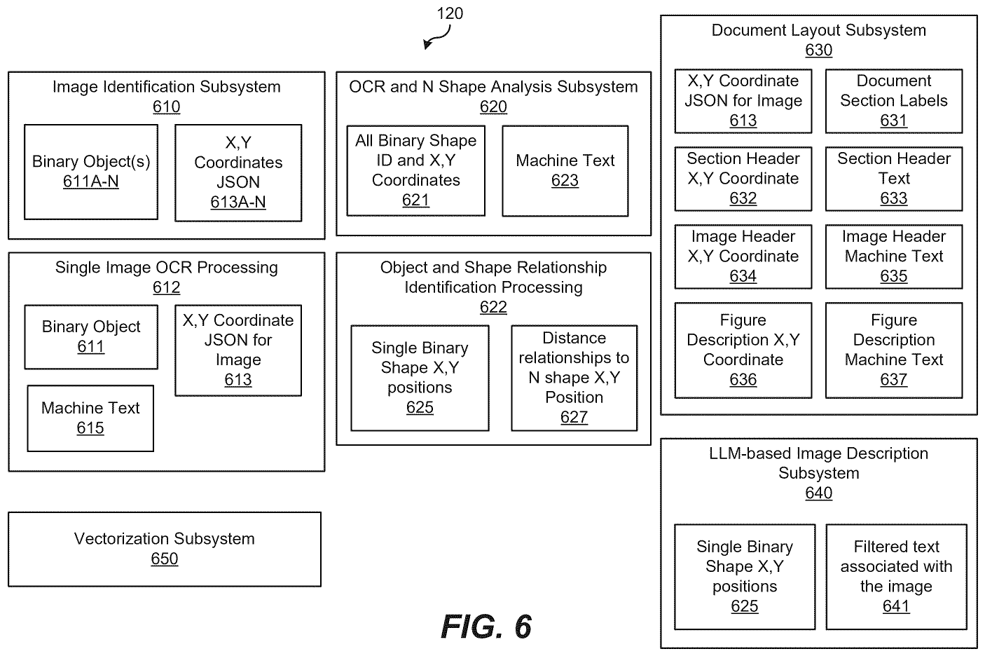

To address these and other problems, the image understanding subsystem 120 may include systems and functionality to identify, extract, understand, and vectorize an image from electronic documents 11. To illustrate, reference will be made to FIG. 6, which illustrates an example 600 of an architecture and data flow of the image understanding subsystem 120, according to an implementation. The description of FIG. 6 will include references to the previous figures for illustration.

The image understanding subsystem 120 may include an image identification subsystem 610, an OCR and N shape analysis subsystem 620, a document layout subsystem 630, an LLM-based image description subsystem 640, a vectorization subsystem 650, and/or other systems or functions.

The image identification subsystem 610 may identify one or more images (such as an image 210 illustrated in FIG. 2) in an electronic document 11 and output, for each image, a binary object 611 and coordinates 613 of the image in the electronic document 11. Each binary object 611 is a representation of an image that can be stored and retrieved by a computer. For example, a binary object 611 may include a binary image file container that electronically represents the image in an image format such as a JPEG, PNG, TIFF, or other image file format.

To identify and extract each image 210, the image identification subsystem 610 may extract mark-up tags that identify respective images in the electronic document 11. Alternatively (such as when mark-up tags are unavailable), or additionally, the image identification subsystem 610 may perform edge detection on the electronic document 11 to identify the image 210. To perform edge detection, the image identification subsystem 610 may use the computer vision model 153 to identify one or more images via edge detection.

Based on the mark-up tags and/or edge detection, the image identification subsystem 610 may identify one or more coordinates 613A-N for each respective binary object 611A-N. The image identification subsystem 610 may extract each binary object 611 based on its respective coordinates 613 or copy the binary object 611. The extracted or copied binary object 611 is stored in the image object database 163. For example, for each image in a document, a document identifier that identifies the electronic document 11, an image identifier, the binary object 611, the one or more coordinates, and/or other data about the extracted image may be stored in the image object database 163 for later retrieval and processing. These and other data may be formatted according to a structured file representation, such as a JSON file format or other structured key/value pair representation.

The image understanding subsystem 120 may provide the outputs of the image identification subsystem 610 as inputs to single image OCR processing 612 and to the document layout processing subsystem 630 for pipeline processing. Turning first to the single image OCR processing 612, for each of the binary objects 611 from the image identification subsystem 610, the image understanding subsystem 120 may perform single image OCR processing 612 in which each binary object 611 and its corresponding coordinates 613 are analyzed to understand what the image represented by the binary object 611 is meant to convey. During single image OCR processing 612, the image understanding subsystem 120 may use the OCR system 155 to recognize characters in the binary object 611 and generate machine text 615 based on the recognized characters. Machine text is extracted from the object and labeled according to the relationships of objects and stored in the relational database, file or object store, such as the image object database 163.

Processing may then flow to the OCR and N shape analysis subsystem 620, which may identify one or more objects contained within the binary object 611 and generate binary shape identifications and coordinates 261 of each object found in the binary object 611 and machine text 663 (which may be UTF-8/16 encoded) of each object. An object is an image or other image component that is contained within a parent image. For example, an object may include a secondary object, which is contained in the image represented by the binary object 611, also referred to as a “primary object” in the context of objects. The secondary object itself may include its own object, referred to as a tertiary object. The tertiary object may include objects, and so on. Thus, a given image represented by a binary object 611 may have hierarchical relationships between the image and one or more objects, such as secondary and tertiary objects. The binary shape IDs and coordinates 261 identifies each of the objects and their coordinates in which they appear in the binary object 611.

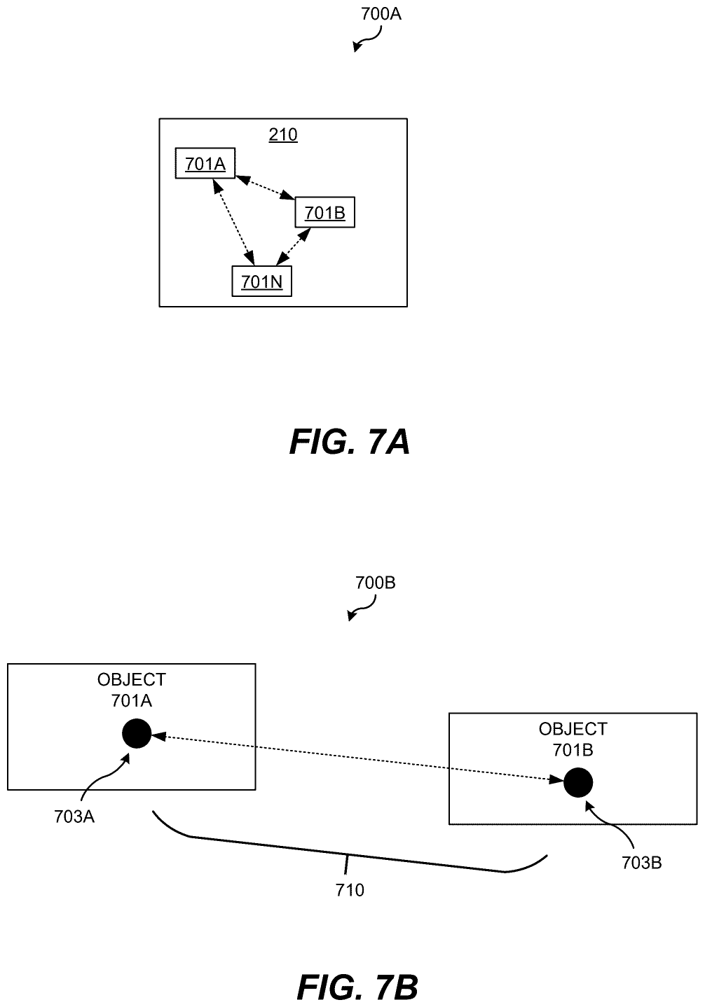

The OCR and N shape analysis subsystem 620 may take as input a binary object 611 and identifies and labels objects contained in the binary object 611, object coordinates, object distances from one another or other reference point, the type of contained object, machine text associated with each object, and the object itself, which may have been extracted from the binary object 611. This process iterates until there are no additional objects found in the main image represented in the binary object 611. It should be noted that searching for objects in the binary object 611 may start at a starting corner (such as an upper, left X coordinate and an upper, left Y coordinate) the binary object 611 and complete at an ending corner (such as a lower, right X coordinate and lower, right Y coordinate). An example of this process is described in more detail with respect to FIG. 7.

The OCR and N shape analysis subsystem 620 may generate machine text 663 for each object that includes characters recognized, a shape identification (ID) and coordinates 261 that identifies the image or sub-image that contained the recognized characters. For each image or sub-image, processing may flow through object and shape relationship identification processing 622, which identifies the positions primary and contained sub-images and calculates the distance relationships between all primary objects, secondary objects, secondary objects to tertiary objects, to “N” objects until there are no additional related objects in a hierarchical fashion from top left X position to bottom right Y position. The output of this processing may include a hierarchical JSON (or other structured key/value pair representation). The data can be stored in relational databases or object storage, such as the image object database 163.

In some instances, an electronic document 11 may include contextual text associated with an image in the electronic document 11, including any images that are linked or associated with the electronic document 11. Contextual text is words or phrases that describe or otherwise provide contextual information for an image. Contextual text may be included in the electronic document 11 as plain text, encoded text, and/or text that is part of the image itself (such as being embedded within an image or shaped within the via pixels that are to be recognized through OCR). Thus, identifying and extracting contextual text for the image will vary depending on the type, which may dictate the location of the contextual text in the electronic document 11, or how the contextual text is included in the electronic document 11, such as whether the contextual text is encoded as such in the electronic document 11 or is included within the image itself. Non-limiting examples of contextual text may include a section header and corresponding text, an image header, and a figure description.

The document layout subsystem 630 may use a layout model 157 to recognize document sections labeled by document section labels 631 and contextual text associated with a given image in an electronic document 11. For example, the document layout subsystem 630 may use one or more layout models 157 to recognize and extract section header and corresponding machine text 633, an image header and corresponding machine text 635, and/or a figure description and corresponding machine text 637. In some instances, each layout model 157 may be trained to identify corresponding types of contextual text. In some instances, a given layout model 157 may be trained to identify two or more types of contextual text.

### Image Headers

The document layout subsystem 630 may isolate the X and Y coordinate position of the extracted image and determine whether an image header was used to label or provide descriptive context to the image in the original document layout or content layout. If the document layout subsystem 630 positively detects an image header was used to label the image, the document layout subsystem 630 identifies the header coordinates 634 at which the header appears in the electronic document 11 and inspects whether or not the text exists inside the image or if it exists as embedded text in the document.

If the image contains the image header, the identified image part or image component is passed through the OCR system 155 to produce machine text, which is then stored in relational database, file or object storage, such as the image object database 163. If the electronic document 11 contains the image header as embedded text inside the document, and not inside the image, the machine text is extracted from the document or mark-up and labeled as the image header and stored in the relational database, file or object store, such as the image object database 163.

### Figure Description

The document layout subsystem 630 may isolate the X and Y coordinate position of the extracted image and determine whether or not a figure description was used to label or provide descriptive context to the image in the original document layout or content layout. If the document layout subsystem 630 positively detects a figure description was used to label the image, the document layout subsystem 630 identifies the figure description coordinates 636 at which the figure description appears in the electronic document 11 and inspects whether or not the text exists inside the image or if it exists as embedded text in the document.

If the image contains the figure description, the identified image part or image component is passed through the OCR system 155 to produce machine text, which is then stored in relational database, file or object storage, such as the image object database 163. If the electronic document 11 contains the figure description as embedded text inside the document, and not inside the image, the machine text is extracted from the document or mark-up and labeled as the figure description and stored in the relational database, file or object store, such as the image object database 163.

### Section Header and Text

The document layout subsystem 630 may identify and extract text in a section of the electronic document 11. The section may include text surrounding, above, below, adjacent to, or within a predefined distance of location of the image such as the top-left x position coordinate and bottom-right y position coordinate. If the document layout subsystem 630 positively detects a section header and its text, the document layout subsystem 630 identifies the section header coordinates 632 at which the section header appears in the electronic document 11 and inspects whether or not the text exists inside the image or if it exists as embedded text in the document. If the section header text 633 is inspected and identified to be machine text, the text is accessed and stored in the relational database, file or object store, such as the image object database 163. If the section header text 633 is inspected and identified by the document layout subsystem 630 to be image-based text, the document layout subsystem 630 may pass the image or image object passed to the OCR system 155 to extract the section text, which is then stored in a relational database, file or object storage, such as the image object database 163.

### Generating an Overall Image Description Based on Text or Characters Recognized From or Associated With the Image and Computer Vision Analysis of the Image

The LLM-based image description subsystem 240 may generate an overall image description 241 of each of the images 310 based on the identified images and text/characters from one or more of the components illustrated in FIG. 2. For example, the LLM-based image description subsystem 240 may generate a description of an image 210 based on the processing output of the image identification subsystem 610, the single image OCR processing 612, the OCR and N shape analysis subsystem 620, the object and shape relationship identification processing 622, and/or the document layout subsystem 630.

In particular, the LLM-based image description subsystem 240 may generate a text-based description of an image 210 based on characters recognized in the image 210 or other images 310, based on a text input that may include the section header machine text 633, image header machine text 635, figure description machine text 637, relevant text from the electronic document 11, and/or other characters or text associated with the image 210.

For example, the LLM-based image description subsystem 240 may activate the language model 159 to describe the image 210 based on text and/or image inputs. For example, the LLM-based image description subsystem 240 may prompt the language model 159 to identify any of the text or characters in the image object database 163 associated with the image 210 that is related to, associated with, or was used to describe the image 210. The LLM-based image description subsystem 240 may further prompt the language model 159 to describe the image 210 based on the identified text or characters.

In a non-limiting example, the LLM-based image description subsystem 240 may generate a prompt (1): “Your job is to act as a multi-modal image understanding tool to: 1. First, read through the extracted optical character recognition (OCR) or other text associated with the image and create a detailed description of the image based on the x and y positioning of the extracted text objects to understand what this image may be describing or what information the image could potentially visually convey to a human. Write this down as ‘OCR Description’.” The LLM-based image description subsystem 240 may activate the language model 159 by providing the prompt (1) to the language model 159, along with access to the text, coordinate, and other data stored in association with the image in the image object database 163. In response, the language model 159 generates an “OCR Description” based on prompt (1) and the data stored in association with the image 210 in the image object database 163.

In some instances, the LLM-based image description subsystem 240 may prompt the language model 159 to describe the image 210 based on the image itself (such as based on the image object that represents the image 210) to thereby generate an image-based description. In a non-limiting example, the LLM-based image description subsystem 240 may provide access to the image 210, such as by placing copying the image 210 into a filesystem accessible to the language model 159, and generate a prompt (2): “Second, as a multi-modal image understanding tool, view the image here ///IMAGE FILE INPUT TO LANGUAGE MODEL/// as a human would and describe in detail what the image could potentially visually convey to a human. Write this down as ‘Vision Transformer Description: ’.” In response, the language model 159 generates a “Vision Transformer Description” based on prompt (2) and the image 210.

When the OCR and text-based description (which may also be referred to as an “OCR Description”) and the image-based description (which may also be referred to as a “Vision Transformer Description”) are generated, the LLM-based image description subsystem 240 may activate the language model 159 to generate the overall image description based on a comparison of the image-based description and the image-based description. For example, in a non-limiting example, the LLM-based image description subsystem 240 may generate a prompt (3): “Compare and contrast the output of the ‘OCR Description’ and ‘Vision Transformer Description’ and infer a complete detailed description from the two inputs. Write this down as ‘Overall Image Description’.” In response, the language model 159 generates the Overall Image Description based on prompt (3), the OCR Description, and the Vision Transformer Description.

### Identifying and Extracting Relevant Text the Language Model Used to Understand the Image

In some examples, identified text or characters may also be used to filter out irrelevant text or characters from the image object database 163 that is associated with the image 210 but was not identified by the language model 159 as being related to, associated with, or used to describe the image 210. In this way, only relevant text or characters for describing the image 210 are stored in association with the image 210. For example, the LLM-based image description subsystem 240 may generate a prompt (4): “Your job is to read the ‘Overall Image Description’ and find the text in the top layout section and bottom layout section that was used to generate the ‘Overall Image Description.’ Copy all text used, including any figures descriptions or other text you used, and place in a new hierarchical JSON structure.” Responsive to prompt (4), the language model 159 may identify and output relevant text used to generate the overall image description.

### Vectorizing the Overall Image Description and/or Relevant Text for Semantic Image Searching and Training a Generative AI Model to Generate New Images

The vectorization subsystem 260 may generate vectors from text, such as the overall figure description. A vector is a numeric representation of data that machine learning and other computer systems can use to learn relationships among the data. In the context of semantic image searching, input text or text derived from an image may be used to semantically search against overall image descriptions that have already been vectorized. In particular, the vectorization subsystem 260 may generate a vector based on text used by the language model 159 to generate the overall figure description for each image. For example, the vectorization subsystem 260 may generate a vector for the overall figure description, the outputs of prompt (4), and/or other relevant text (such as the document section labels 631, section header text 633, the image header machine text 635, and/or figure description machine text 637 used by the language model 159 to generate the overall image description. This vector may be stored along with the vectors of respective other images against which an input vector is semantically searched.

### Semantic Image Retrieval Based on the Stored Vectors

Semantic image retrieval is a computer process of retrieving responsive to input queries, images based on the meaning they convey, as determined by the image understanding subsystem 120. Semantic similarity is a measure of similarity based on semantic content (meaning, context, or structure of words) rather than keyword matching. For example, “transportation” may be semantically similar to “automobile.” In the context of image searching as disclosed herein, semantic image similarity may refer to the similarity between what an image conveys and a query input.

The semantic image searching subsystem 130 may enable semantic image retrieval based on a query input that includes text and/or an image. Text in the query input may be based on the natural language description alone or in combination with other text input. Text in the query input may be vectorized, such as by the vectorization subsystem 250, for comparison with the vectors associated with images in the image database 125. For example, the semantic image searching subsystem 130 may access a natural language question, keyword, or series of keywords. In particular, a user may, via user interface provided by the interface subsystem 150, enter a natural language question, keyword or series of keywords into an input area and submit a search request. Responsive to the search request, the semantic image searching subsystem 130 may vectorize the query text, and evaluate the embedding vectors of the query text against the output vectors of images 310 in the image database 125 based on vector similarity. Vector similarity may be measured by determining the closeness of one or more (typically though not necessarily multiple) values of compared vectors. Examples of vector similarity techniques may include, a hybrid search, a SPLADE search, pure semantic search, a DOT product, a Levenshtein distance, a cosine distance, and/or other similarity technique that can measure the similarity between vectors.

The semantic image searching subsystem 130 may return a list of the most semantically related images (top N images, where N is a predefined and configurable integer) and their related text, and presents the list to the user in the user interface. This list can be further refined or re-ordered using secondary weighted models according to a number of collected attributes, including date time groups.

In some instances, the query input may include one or more query images that are to be searched to find semantically similar images. For example, the user may upload one or more query images or otherwise indicate their locations and submit a search request to find semantically similar images. Semantically similar images are images that convey the same meaning as one another rather than merely sharing pixel similarity or matching keyword tags. Other ways to enter query inputs may be used as well or instead. If the query input includes an image input, the semantic image searching subsystem 130 may transform the image into multi-modal image embedding vectors as a whole first and/or based on text recognized from or otherwise associated with the image. For example, the semantic image searching subsystem 130 may use the image understanding subsystem 120 to generate a natural language description of the input image, similar to the manner described with respect to an image 210. The semantic image searching subsystem 130 may vectorize the natural language description and perform a semantic image search similar to the way in which embedding vectors using input query text was performed. Semantic image searches and image results may be used in various contexts. For example, semantic image searching may be used in the context of retrieving relevant images to incorporate into a document, generating new images, comparison of various images to one another, and/or other contexts.

### Image Output Comparisons

In some instances, semantic image search disclosed herein may enable comparison of human-generated text and generative AI-generated text in finding images. For example, human-generated text such as a response to a Request For Proposal (RFP) may be vectorized and used to semantically search images by evaluating the embedding vectors derived from the human-generated text against the embeddings from the image database 125. Likewise, AI-generated text such as a response to the RFP generated by an LLM may be vectorized and used to semantically search images in the image database 125. Resulting images may be compared and selected for inclusion in a document and/or for generating new images.

The language model API endpoint 140 may be a Uniform Resource Locator (URL) or other address to interface with and execute the language model 159. The language model API endpoint 140 may expose a search service of the language model 159. The search service may search against documents provided to it. The search service may be used to obtain results, including computer generated content from the language model 159 based on one or more input prompts, examples of which are described herein for illustration. In some examples, the language model 159 may be a language model, in which case the inputs to the language model 159 may include multiple input/output modalities such as text, images, sound, and the like.

The interface subsystem 150 may provide one or more user interfaces to interact with or otherwise receive or transmit data to users via client devices 105. The user interfaces may include semantic search interfaces for inputting text, image, and/or other query input, interfaces for displaying semantic image search results, interfaces for generating or incorporating images into documents, and/or other interfaces.

Processor 112 may be configured to execute or implement 120, 130, 140, and 150 by software; hardware; firmware; some combination of software, hardware, and/or firmware; and/or other mechanisms for configuring processing capabilities on processor 112. It should be appreciated that although 120, 130, 140, and 150 are illustrated in FIG. 1 as being co-located in the computer system 110, one or more of the components or features 120, 130, 140, and 150 may be located remotely from the other components or features. The description of the functionality provided by the different components or features 120, 130, 140, and 150 described below is for illustrative purposes, and is not intended to be limiting, as any of the components or features 120, 130, 140, and 150 may provide more or less functionality than is described, which is not to imply that other descriptions are limiting. For example, one or more of the components or features 120, 130, 140, and 150 may be eliminated, and some or all of its functionality may be provided by others of the components or features 120, 130, 140, and 150, again which is not to imply that other descriptions are limiting. As another example, processor 112 may include one or more additional components that may perform some or all of the functionality attributed below to one of the components or features 120, 130, 140, and 150.

One or more client devices 105 may include various types of devices that may be used by an end user to interact with the computer system 110. For example, client devices 105 may include a desktop computer, laptop computer, tablet computer, smartphone, and/or other types of devices that may communicate with the computer system 110.

FIG. 7A illustrates an example of identifying objects (such as primary objects, secondary objects, tertiary objects, and so on through N objects) and determining hierarchical relationships of the identified objects. For instance, the computer system 110 may identify a plurality of (two or more) objects 701A-N and relationships between them (illustrated as dashed lines). For a given pair of objects 701, the computer system 110 may determine a relationship and other information about each object in the pair. In some examples, the computer system 110 may repeat this analysis for at least some of all possible pairs of objects. In some examples, the computer system 110 may repeat this analysis all possible pairs of objects 701. To illustrate, reference will now be made to FIG. 7B.

FIG. 7B illustrates an example of determining relationships between a pair of objects 701A and 701B based on their respective positions in an image. It should be noted that the pair of objects 701A and 701B may be two primary objects, a primary and a secondary object, a primary object and a tertiary object, a secondary object and a tertiary object, and other combinations of objects. The computer system 110 may determine relationship information based on the pair of objects 701A and 701B. For example, the computer system 110 may determine a distance 710 between the pair of objects 701A and 701B. The distance 710 may be computed based on a common reference point in each of the objects 701A and 701B. For example, the distance 710 may be a distance between centroids of objects 701A and 701B, a distance between outer edges (such as the rightmost edge of each object 701A and 701B), and/or a distance between other reference points. In some examples, the distance may be computed based on an average of more than two of these or other distance metrics. Based on the distance 710, an absolute distance between objects may be determined. Further based on the distance 710, a relative position between objects may be determined. For example, the computer system 110 may determine that the object 701A is to the left of object 701B, which is to the right of object 701N, and so on.

The computer system 110 may store multiple pairs of relationships to build a hierarchical network of object relationships. The hierarchical network of object relationships may be used to understand how objects in each image are arranged with respect to one another. These relationships may be used as features for training machine learning models to identify patterns in image datasets to be able to generate new images based on the learned patterns. Diffusion models may be applied to randomly introduce differences in the patterns to generate new images as well.

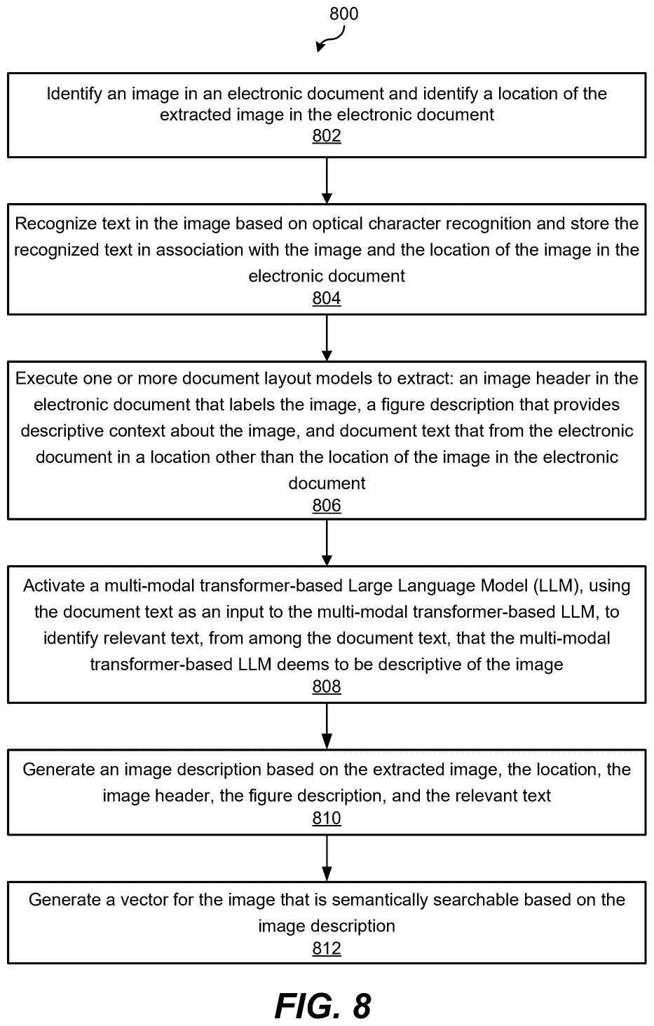

FIG. 8 shows an illustrative method 800 for computationally determining an understanding of an image, according to an implementation.

At 802, the method 800 may include identifying an image in an electronic document and identify a location of the extracted image in the electronic document. At 804, the method 800 may include recognizing text in the image based on optical character recognition and store the recognized text in association with the image and the location of the image in the electronic document. At 806, the method 800 may include executing one or more document layout models to extract: an image header in the electronic document that labels the image, a figure description that provides descriptive context about the image, and document text that from the electronic document in a location other than the location of the image in the electronic document.

At 808, the method 800 may include activating a multi-modal transformer-based Large Language Model (LLM), using the document text as an input to the multi-modal transformer-based LLM, to identify relevant text, from among the document text, that the multi-modal transformer-based LLM deems to be descriptive of the image. At 810, the method 800 may include generating an image description based on the extracted image, the location, the image header, the figure description, and the relevant text. At 812, the method 800 may include generating a vector for the image that is semantically searchable based on the image description.

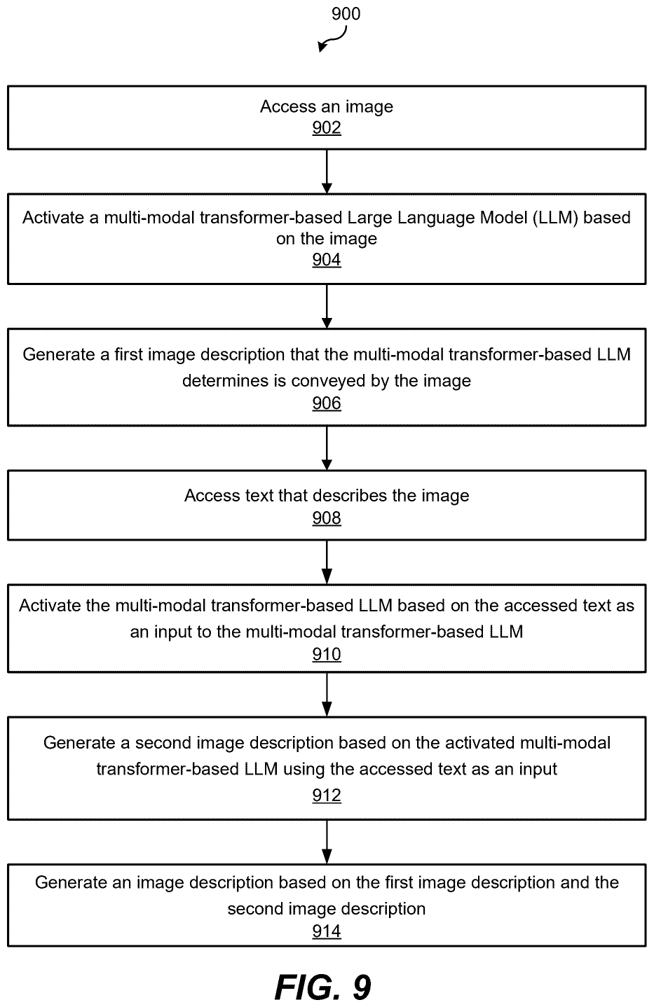

FIG. 9 shows another illustrative method 900 for computationally determining an understanding of an image, according to an implementation.

At 902, the method 900 may include accessing an image. For example, the image may be accessed from an electronic document and/or from a repository of images.

At 904, the method 900 may include activating a multi-modal transformer-based Large Language Model (LLM) based on the image.

At 906, the method 900 may include generating a first image description that the multi-modal transformer-based LLM determines is conveyed by the image. At 908, the method 900 may include accessing text that describes the image. At 910, the method 900 may include activating the multi-modal transformer-based LLM based on the accessed text as an input to the multi-modal transformer-based LLM.

At 912, the method 900 may include generating a second image description based on the activated multi-modal transformer-based LLM using the accessed text as an input. At 914, the method 900 may include generating an image description based on the first image description and the second image description.

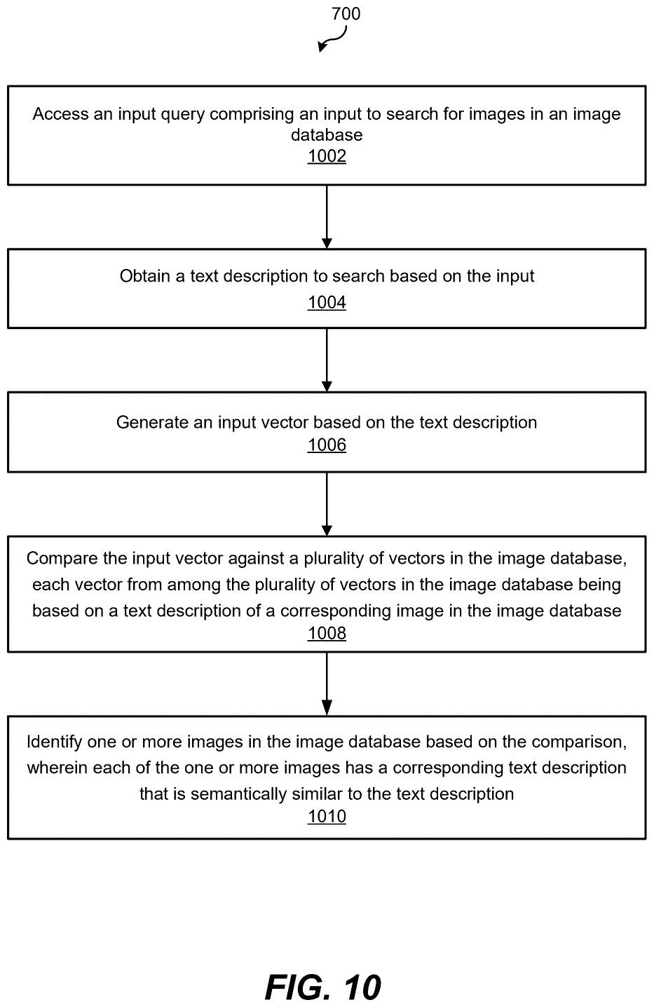

FIG. 10 shows an illustrative method 1000 for semantically searching images based on computationally determined understanding of images, according to an implementation. At 1002, the method 1000 may include accessing an input query comprising an input to search for images in an image database. At 1004, the method 1000 may include obtaining a text description to search based on the input. At 1006, the method 1000 may include generating an input vector based on the text description. At 1008, the method 1000 may include compare the input vector against a plurality of vectors in the image database, each vector from among the plurality of vectors in the image database being based on a text description of a corresponding image in the image database. At 1010, the method 1000 may include identifying one or more images in the image database based on the comparison, wherein each of the one or more images has a corresponding text description that is semantically similar to the text description.

As used herein, the term “A-N,” such as document sources 101A-N is intended to mean “one or more” and not a specific number. Any illustrated number of components in the Figures bearing this term does not necessarily mean that specific number is required, unless specifically noted otherwise.

The computer system 110 and the one or more client devices 105 may be connected to one another via a communication network (not illustrated), such as the Internet or the Internet in combination with various other networks, like local area networks, cellular networks, or personal area networks, internal organizational networks, and/or other networks. It should be noted that the computer system 110 may transmit data, via the communication network, conveying the predictions to one or more of the client devices 105. The data conveying the predictions may be a user interface generated for display at the one or more client devices 105, one or more messages transmitted to the one or more client devices 105, and/or other types of data for transmission. Although not shown, the one or more client devices 105 may each include one or more processors.

Each of the computer system 110 and client devices 105 may also include memory in the form of electronic storage. The electronic storage may include non-transitory storage media that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information obtained from servers, information obtained from client devices, or other information that enables the functionalities described herein.

The databases and data stores (such as 125) may be, include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

The systems and processes are not limited to the specific implementations described herein. In addition, components of each system and each process can be practiced independently and separately from other components and processes described herein. Each component and process can also be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system features illustrated in FIG. 1.

This written description uses examples to disclose the implementations, including the best mode, and to enable any person skilled in the art to practice the implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system, comprising:
one or more processors programmed to:
identify an image in an electronic document and identify a location of the extracted image in the electronic document;
recognize text in the image based on optical character recognition and store the recognized text in association with the image and the location of the image in the electronic document;
execute one or more document layout models to extract: an image header in the electronic document that labels the image, a figure description that provides descriptive context about the image, and document text that from the electronic document in a location other than the location of the image in the electronic document;
activate a multi-modal transformer-based Large Language Model (LLM), using the document text as an input to the multi-modal transformer-based LLM, to identify relevant text, from among the document text, that the multi-modal transformer-based LLM deems to be descriptive of the image;
generate an image description based on the extracted image, the location, the image header, the figure description, and the relevant text; and
generate a vector for the image that is semantically searchable based on the image description.

2. The system of claim 1, wherein to generate the image description, the processor is further programmed to:
execute the multi-modal transformer-based LLM, using the image as an input to the multi-modal transformer-based LLM, to generate a first image description that the multi-modal transformer-based LLM determines is conveyed by the image;
execute the multi-modal transformer-based LLM, using text input as an input to the multi-modal transformer-based LLM, to generate a second image description, wherein the text input comprises the image header, the figure description, and the relevant text; and
generate the image description based on the first image description and the second image description.

3. The system of claim 2, wherein to generate the image description, the processor is further programmed to:
execute the multi-modal transformer-based LLM to compare the first image description and the second image description to generate the image description.

4. The system of claim 1, wherein the processor is further programmed to:
recognize a primary object in the image;
determine a coordinate position of the primary object in the image; and
generate a primary object record that stores the coordinate position and the primary object in association with one another.

5. The system of claim 4, wherein the processor is further programmed to:
identify a secondary object contained in the primary object;
determine a second coordinate position of the secondary object in the image;
determine a relational distance between the primary object and the secondary object;
generate a secondary object record that stores a linkage between the primary object and the secondary object, the relational distance and the second coordinate position.

6. The system of claim 5, wherein to determine the relational distance between the primary object and the secondary object, the processor is further programmed to:
identify a first position of the primary object in the image and a second position of the secondary object in the image; and
generate the relational distance based on the first position and the second position.

7. The system of claim 5, wherein the processor is further programmed to:
identify a tertiary object contained in the image;
determine a third coordinate position of the tertiary object in the image;
determine a third relational distance between the primary object, the secondary object, and the tertiary object; and
generate a tertiary object record that stores a linkage between the primary object, the secondary object, and the tertiary object, the second coordinate position, and the third relational distance.

8. The system of claim 1, wherein the processor is further programmed to:
access an input query comprising an input to search for images in an image database;
obtain a text description to search based on the input;
generate an input vector based on the text description; and
compare the input vector against a plurality of vectors in the image database, each vector from among the plurality of vectors in the image database being based on a text description of a corresponding image in the image database; and
identify one or more images in the image database based on the comparison, wherein each of the one or more images has a corresponding text description that is semantically similar to the text description.

9. The system of claim 8, wherein the input comprises an image input, and wherein the processor is further programmed to:
determine the text description based on the input image; and
generate an input vector based on the description of the input image.

10. The system of claim 8, wherein the input comprises a text input comprising the text description.

11. The system of claim 1, wherein to identify the image, the processor is programmed to:
identify the image based on edge detection using a computer vision model.

12. The system of claim 1, wherein to identify the image, the processor is programmed to:
identify the image based on one or more image tags from the electronic document that identifies the image.

13. A method, comprising:
accessing an image;
activating a multi-modal transformer-based Large Language Model (LLM) based on the image;
generating a first image description that the multi-modal transformer-based LLM determines is conveyed by the image;
accessing text that describes the image;
activating the multi-modal transformer-based LLM based on the accessed text as an input to the multi-modal transformer-based LLM;
generating a second image description based on the activated multi-modal transformer-based LLM using the accessed text as an input; and
generating an image description based on the first image description and the second image description.

14. The method of claim 13, wherein generating the image description comprises:
activating the multi-modal transformer-based LLM based on an input instruction to compare the first image description and the second image description; and
generating the image description as an output of the activated multi-modal transformer-based LLM based on the instruction to compare the text-based description and the image-based description.

15. The method of claim 13, further comprising:
generating, based on the image description, a vector for the image; and
storing the vector in a semantically searchable image database to make the image semantically searchable in the semantically searchable image database based on the image description.

16. The method of claim 15, further comprising:
accessing an input query comprising an input image;
determining a description of the input image;
generating an input vector based on the description of the input image; and
identifying one or more semantically similar images in the semantically searchable image database based on semantic similarity between the input vector and a plurality of vectors in the semantically searchable image database, wherein each of the plurality of vectors corresponds to a respective image that was previously vectorized for semantic search.

17. The method of claim 15, further comprising:
accessing an input query comprising a input text;
generating an input vector based on the input text; and
identifying one or more semantically similar images in the semantically searchable image database based on semantic similarity between the input vector and a plurality of vectors in the semantically searchable image database, wherein each of the plurality of vectors corresponds to a respective image that was previously vectorized for semantic search.

18. A non-tangible computer readable medium that stores instructions, the instructions when executed by a processor programs the processor to:
access an input query comprising an input to search for images in an image database;
obtain a text description to search based on the input;
generate an input vector based on the text description;
compare the input vector against a plurality of vectors in the image database, each vector from among the plurality of vectors in the image database being based on a text description of a corresponding image in the image database; and
identify one or more images in the image database based on the comparison, wherein each of the one or more images has a corresponding text description that is semantically similar to the text description.

19. The non-tangible computer readable medium of claim 18, wherein the input comprises an image input, and wherein the instructions when executed further programs the processor to:
determine the text description based on the input image; and
generating an input vector based on the description of the input image.

20. The non-tangible computer readable medium of claim 18, wherein the input comprises a text input comprising the text description.
